(19) United States
(12) Patent Application Publication
(10) Pub. No.: US 2007/0079111 A1
(43) Pub. Date: Apr. 5, 2007

(54) Activating method of computer multimedia function

(76) Inventor: Chiu-Fu Chen, Taipei County (TW)

Correspondence Address: HARNESS, DICKEY & PIERCE, P.L.C., P.O. BOX 8910, RESTON, VA, 20195, US

(21) Appl. No.: 11/239,290

(22) Filed: Sep. 30, 2005

(51) Int. Cl. G06F 15/177

(52) U.S. Cl. 713/1

(57) ABSTRACT

An activating method of a computer multimedia function is implemented to load in a multimedia operating system. The method includes when a multimedia on-switch mode signal is received, setting accordingly the host protection area to an access status; loading the on-switch loading program stored in the host protection area in the memory; and executing the on-switch loading program to load in the multimedia operating system and its corresponding application program to broadcast multimedia data.

### BACKGROUND OF THE INVENTION

1. Field of Invention

The present invention relates to an activating method of a computer multimedia function, and particularly to the implementation of an on-switching loading program and a multimedia operating system stored in a host protection area to achieve computer multimedia functions.

2. Related Art

In early times, the computer was usually used to execute complex and repetitive calculation tasks. However, as the technology progresses, the computer now goes multimedia and integrates many components such as a sound card, an optical disk drive, speakers and a microphone. Further, the advance of the operating system and multimedia technology allows the computer to perform audio-video entertainment such as broadcasting music (for example, broadcast WAV, MIDI, MP3 or like sound formats, or directly plays music from an audio optical disk) and movies (for example, broadcast MPEG, AVI, ASF, RM or like movie formats, or directly plays a movie from an audio-video optical disk).

A conventional home multimedia appliance (such as a television set, a radio, and a DVD player) usually is immediately ready to play as soon as it is switched on, and there is no need to wait a long on-switch time. However, if a computer is to be used to broadcast multimedia data (such as pictures, music, movies, etc.), the computer on-switch sequence must be executed to load the normal operating system needed to manipulate the computer (such as the operating system “Windows”, LINUX, etc.) before the application programs can be effectively run to broadcast the multimedia data. Depending on the grade of the computer (CPU clock, memory capacity, data bus transmission speed, etc.), the computer on-switch time may vary significantly. However, an average waiting time of at least 1 to 2 minutes is usually necessary.

Though the multimedia computer can offer audio-video entertainment functionality, the multimedia broadcasting function is still built in the normal operating system. Actually, if the computer is used only for its multimedia functions, the operating system kernel is sufficient to manipulate the computer multimedia devices and there is no need of the whole operating system, which can reduce the computer on-switch waiting time and render its use as convenient as the traditional home multimedia appliance.

As shown in FIG. 1a, to reduce the computer on-switch time and ensure that the original operating system can work normally, a conventional approach installs two operating systems on different hard disk partitions. A normal operating system 14 is stored in a first hard disk partition 12 to support convention computer operations, while a multimedia operating system 15 is stored in a second hard disk partition 13. The multimedia operating system 15 can be the Windows operating platform, the LINUX operating platform or other operating platforms. The multimedia operating system 15 is an operation system kernel. When the computer is switched on, the basic input output system (BIOS) 10 searches the active partition of the hard disk, and loads the operating system of the active partition. For example, when the first hard disk partition 12 is an active partition, the normal operating system 14 is loaded in. In contrast, if the second hard disk partition 13 is the active partition, the multimedia operating system 15 is loaded in.

Because the above multimedia operating system 15 is stored in the second hard disk partition 13 without protection, the normal operating system 14 can access to the second hard disk partition 13 to store data. The data stored in the second hard disk partition 13 thus can be easily damaged (for example, by computer viruses or by erroneously erasing on-switch files). As a result, the multimedia operating system 15 can be adversely affected. Safely protecting the multimedia operating system can overcome the above problems.

### SUMMARY OF THE INVENTION

To solve the above problems, the present invention stores the multimedia operating system (or just only the kernel of multimedia operating system in a preferred embodiment) in a host protection area to protect it against damage. The multimedia operating system only includes an operation system kernel sufficient to drive multimedia devices to shorten the loading time of the multimedia operating system. The invention further provides an on-switch activating process of the multimedia operating system to load in the multimedia operating system. Because the host protection area must be accessed via the BIOS, the data of the multimedia operating system is not easily damaged.

The invention further provides a conventional on-switch mode to load a normal operating system from a hard disk partition into a memory to provide the user with necessary computing services. The invention also provides a multimedia on-switch mode in which the multimedia operating system and the corresponding application program stored in the host protection area are loaded in for watching television, VCD, DVD, or listening to music compact disks MP3, radio, or browsing photos (photo files stored on an optical disk, hard disk and memory cards, etc.). The multimedia functions of the computer can be thereby more conveniently performed.

Furthermore, the invention provides a plurality of multimedia operating systems in the host protection area which are adapted to different multimedia uses (for example, music, movies, etc.) or multimedia devices. The user can selectively load the desired multimedia operating system. The implemented method includes loading a specific multimedia operating system according to different interruption commands received when the computer is switched on. For example, different on-switch mode selection switches, touching different keyboard functional keys or manipulating the mouse can be operated to generate the interruption signal.

To achieve the above and other objectives, the invention provides an activating method of a computer multimedia function comprising the following steps.

First, the user switches on the computer, which generates a power-activating signal. The computer accordingly executes an on-switch activating sequence, and loads the BIOS into the memory, executes the power on self test sequence, and detects a multimedia on-switch mode signal to determine whether either a normal operating system or a multimedia operating system is to be loaded in. When the multimedia on-switch mode signal is detected, the BIOS sets the host protection area to an access status, and reads the on-switch loading program stored in the host protection area into the memory. The on-switch loading program then loads in the multimedia operating system and the application program stored in the host protection area. If no multimedia on-switch mode signal is detected, the BIOS sets the host protection area to a protection status and loads in the normal operating system.

The loading process of the multimedia operating system further comprises the following steps. When a multimedia on-switch mode signal is received during computer on switching, the BIOS sets the host protection area to an access status. The on-switch loading program stored in the host protection area then is read into the memory. The on-switch loading program then is executed to load the multimedia operating system and the application program stored in the host protection area.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given in the illustration below only, and thus doesn't limit the present invention, wherein:

FIG. 1a is a schematic view illustrating the operation of the activating method of a computer multimedia function according to an embodiment of the invention;

FIG. 1b is a schematic view of the activating method of a computer multimedia function according to an embodiment of the invention;

FIG. 2 is a schematic view of the activating method of a computer multimedia function according to an embodiment of the invention;

FIG. 3 is a flowchart of the activating method of a computer multimedia function according to an embodiment of the invention;

FIG. 4 is a flowchart of the activating method of a computer multimedia function according to an embodiment of the invention; and

FIG. 5 is a flowchart of the activating method of a computer multimedia function according to an embodiment of the invention.

### DETAILED DESCRIPTION OF THE INVENTION

According to the invention, the multimedia operating system is stored in the host protection area. The host protection area is an area defined in the hard disk where a normal operating system cannot access. Access to the host protection area can be performed only via the BIOS. Data stored in the host protection area can be thereby protected against inadvertent damages.

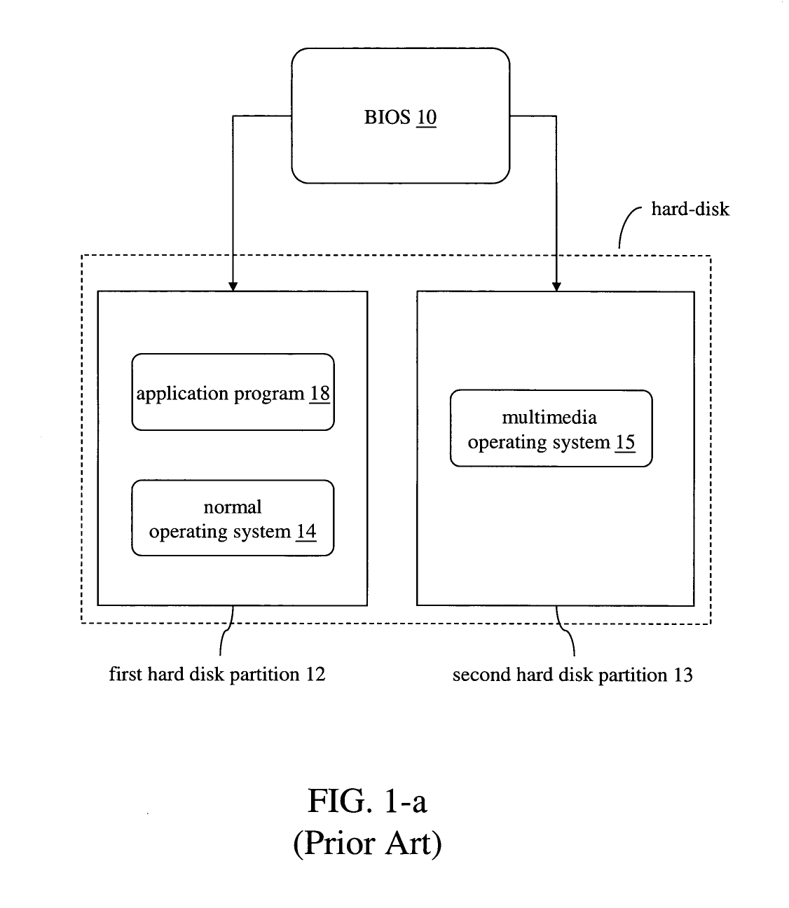

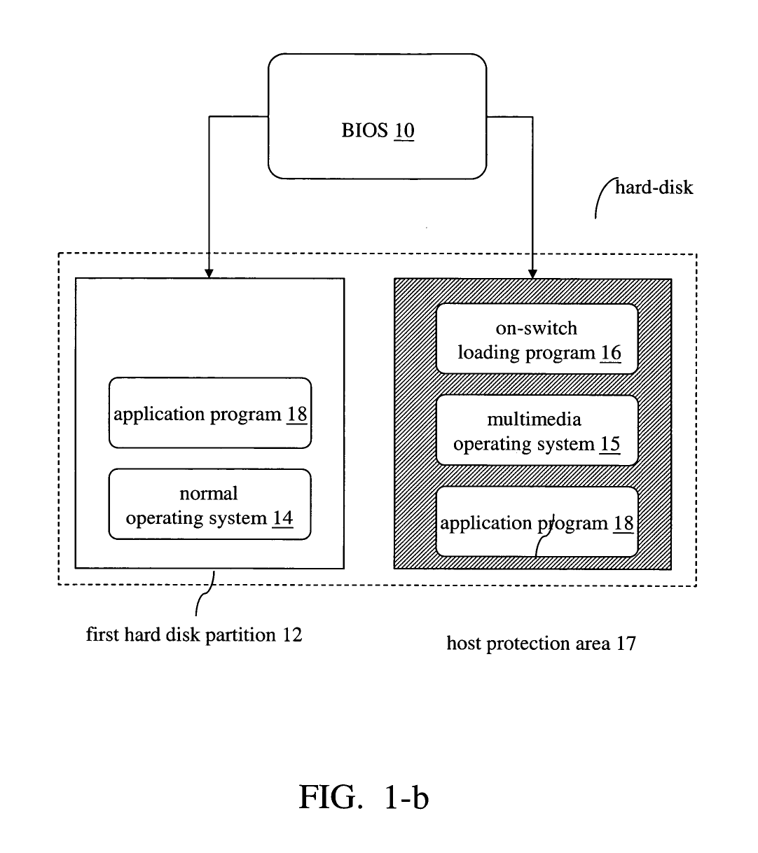

FIG. 1b is a schematic diagram illustrating the activating method of a computer multimedia function according to an embodiment of the invention. A multimedia operating system 15 only includes only the kernel of multimedia operating system in one preferred embodiment (or includes the whole multimedia operating system in another preferred embodiment), capable of operating multimedia devices to shorten the loading time during computer on-switch. The multimedia operating system 15, on-switch loading program 16 and application program 18 are stored in the host protection area 17. Because the host protection area 17 must be accessed via the BIOS 10, data thus can be safely stored in the host protection area 17. The processing method according to the invention is as follows.

While the computer is turned on, the BIOS 10 is loaded in the memory, and a multimedia on-switch mode signal is detected. The multimedia on-switch mode signal is an interruption command (for example, a keyboard functional key command or a mouse operating command). Depending on whether the multimedia on-switch mode signal is received, it is determined whether either the normal operating system 14 or multimedia operating system 15 is to be loaded. For example, when the multimedia on-switch mode signal is detected, the BIOS 10 sets the host protection area 17 to an access status (which means the protection status of the host protection area is off), and reads from the host protection area 17 to the memory the on-switch loading program 16. Subsequently, the on-switch loading program 16 is used to load in the multimedia operating system 15 and application program 18 stored in the host protection area 17. Otherwise, the BIOS 10 sets the host protection area 17 to a protection status, and loads in the normal operating system 14 stored in the first hard disk partition 12.

Since there is conventionally more than one multimedia device coupled with the computer (for example, optical disk drive, sound effect devices, video devices, etc.), a multimedia operating system can be designed corresponding to different multimedia devices so as to simplify the operating system kernel and thereby reduce the loading time of the multimedia operating system 15 stored in the host protection area 17. Further, according to the user's desire, an operating system and application program can be loaded to broadcast different multimedia data (for example, sound data, image data, picture data, etc.), so that the computer can be as convenient as a home audio-video set.

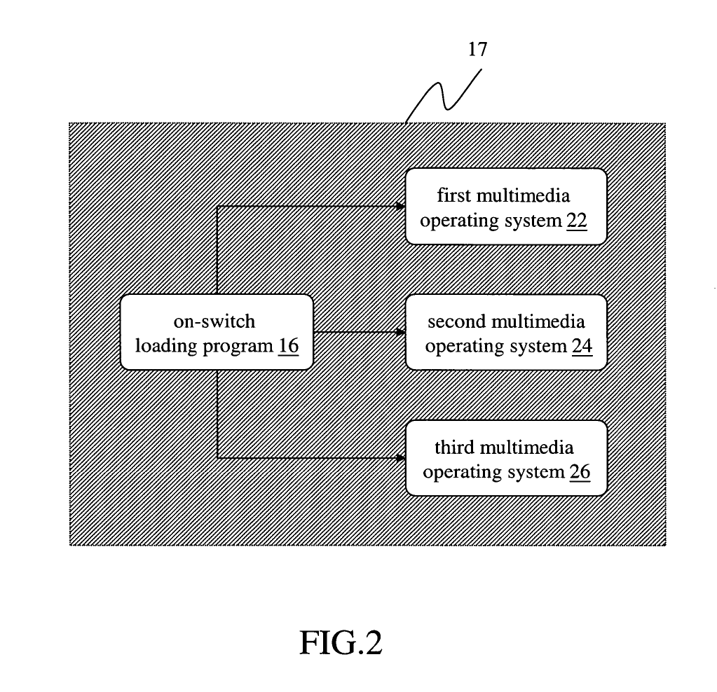

FIG. 2 illustrates the data stored in the host protection area 17. As shown, the stored data include the on-switch loading program 16 and multimedia operating systems designed according to different audio-video applications, such as a first multimedia operating system 22, a second multimedia operating system 24 and a third multimedia operating system 26, for respectively broadcasting music, movies and photos. When the BIOS sets the host protection area to the access status, the on-switch loading program 16 is read into the memory, and the operating system corresponding to the desired application is subsequently loaded in. For example, when the user wants to broadcast music, the on-switch loading program 16 loads the first multimedia operating system 22. If the user wants to broadcast movies, the on-switch loading program 16 loads the second multimedia operating system 24. In contrast, if the user wants to broadcast photos, the on-switch loading program 16 loads the third multimedia operating system 26. The loaded multimedia operating system then drives the corresponding multimedia devices and executes the associated application program.

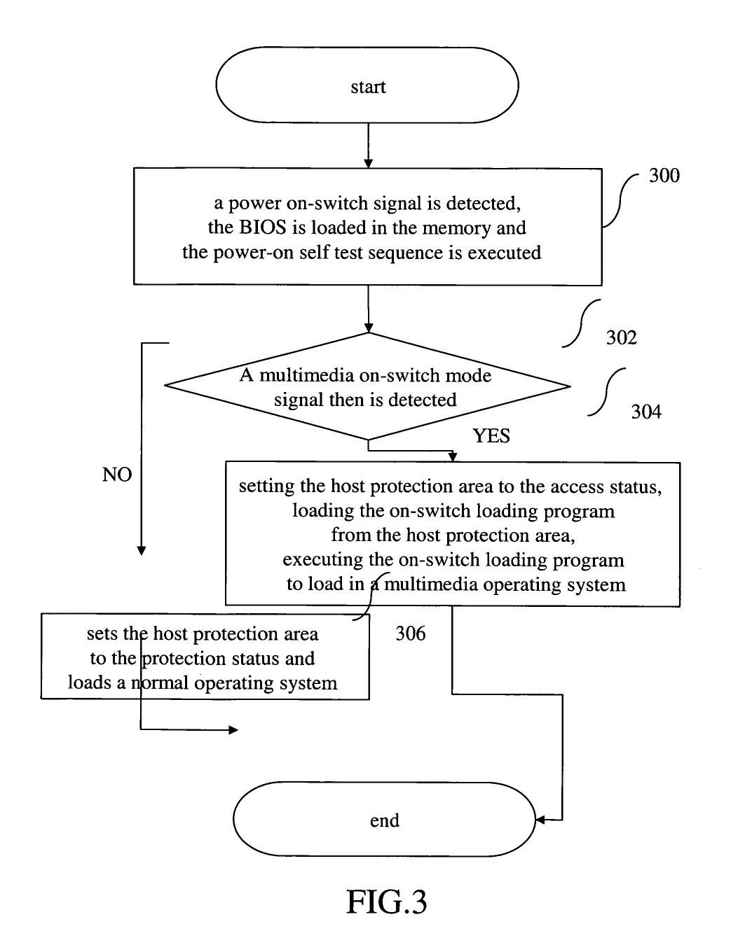

FIG. 3 is a flowchart of the activating method of a computer multimedia function according to an embodiment of the invention, being implemented on a computer executable platform. The computer executable platform includes a normal operating system and a multimedia operating system. The normal operating system is stored in a partition of the hard disk; the multimedia operating system is stored in the host protection area; and the host protection area has two switching statuses: an access status and a protection status. The multimedia operating system is loaded in the following sequence according to the invention.

First, a power on-switch signal is detected, the BIOS is loaded in the memory and the power-on self test sequence is executed (step 300). A multimedia on-switch mode signal then is detected (step 302). The multimedia on-switch mode signal can be received from one shortcut key or combined keys of an input device (for example, a keyboard), as well as from signals of a joystick generating a multimedia on-switch mode signal. Once the multimedia on-switch mode signal is detected, the BIOS executes the following steps: setting the host protection area to the access status, loading the on-switch loading program from the host protection area, executing the on-switch loading program to load in a multimedia operating system, and according to the user's request executing a corresponding application program (step 304). The application program can be an application program conventionally stored in a hard disk partition, as well as an application program stored in the host protection area (for example, a broadcast software). When no multimedia on-switch mode signal is detected, the BIOS sets the host protection area to the protection status and loads a normal operating system (step 306).

The multimedia operating system includes driver programs of multimedia devices such as an optical disk drive, a sound card, a video card, a television card, etc. The multimedia operating system also includes application programs used to broadcast multimedia data (for example, sound data, movie data, image data, etc.). Because the host protection area must be accessed via the BIOS (which means setting the protection status to the access status), the normal operating system cannot directly access to the host protection area. The multimedia operating system stored in the host protection area thus is not easily damaged.

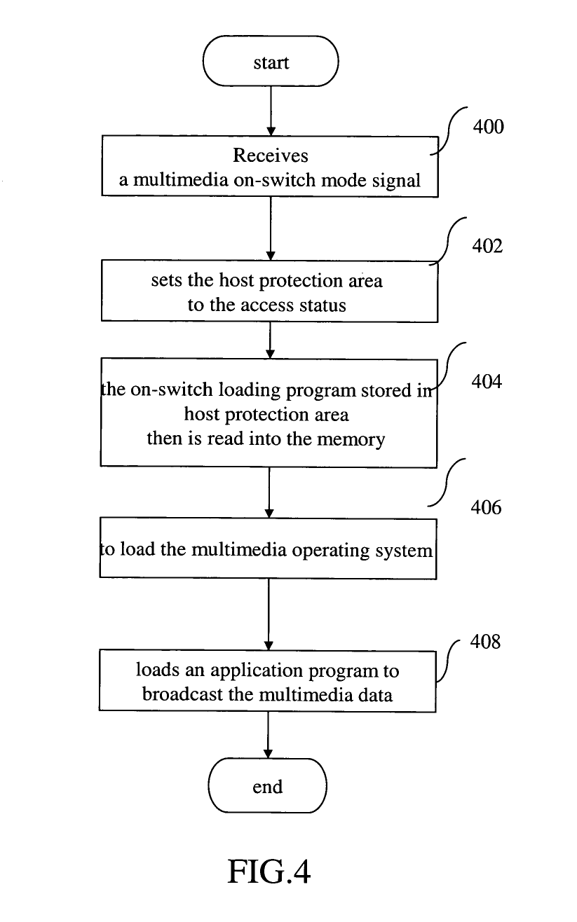

FIG. 4 is a flowchart of the activating method of a computer multimedia function according to an embodiment of the invention, and particularly the loading sequence of the multimedia operating system. When the loading sequence of the multimedia operating system is executed, the BIOS receive a multimedia on-switch mode signal (step 400). The multimedia on-switch mode signal can be received from one shortcut key or combined keys of an input device (for example, a keyboard), as well as from signals of a joystick generating a multimedia on-switch mode signal. The multimedia on-switch mode signal constitutes an interruption command according to which the BIOS sets the host protection area to the access status (step 402). The on-switch loading program stored in host protection area then is read into the memory (step 404). The on-switch loading program is executed to load the multimedia operating system (step 406). According to the user's need, the multimedia operating system loads an application program to broadcast the multimedia data (music, movie and pictures) (step 408).

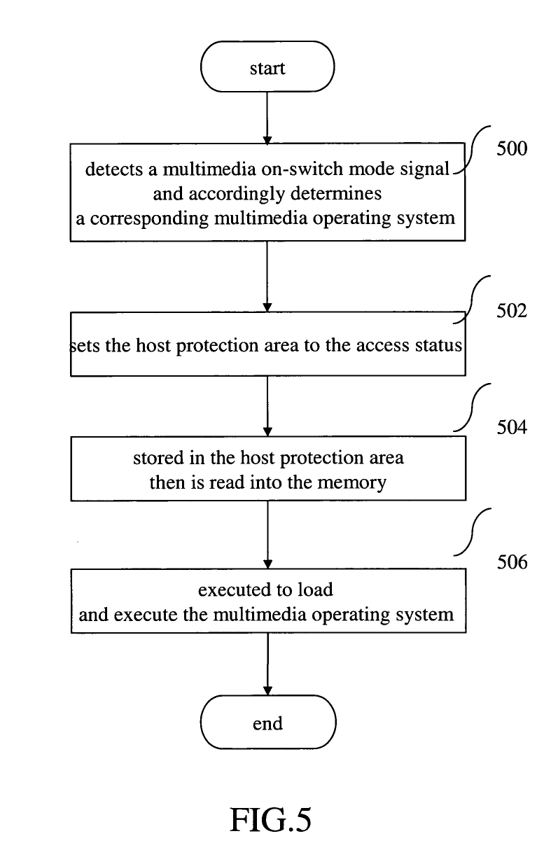

FIG. 5 is a flowchart of the activating method of a computer multimedia function according to an embodiment of the invention, in which different multimedia operating systems are loaded according to the corresponding multimedia on-switch mode signals. A plurality of multimedia operating systems is stored in the host protection area. Each multimedia operating system can drive corresponding multimedia devices and execute corresponding application programs. The BIOS detects a multimedia on-switch mode signal and accordingly determines a corresponding multimedia operating system (step 500). Then the BIOS sets the host protection area to the access status (step 502). The on-switch loading program stored in the host protection area then is read into the memory (step 504). Lastly, the on-switch loading program is executed to load and execute the multimedia operating system (step 506).

It will be apparent to the person skilled in the art that the invention as described above may be varied in many ways, and notwithstanding remaining within the spirit and scope of the invention as defined in the following claims.

What is claimed is:

1. An activating method of a computer multimedia function, being executed on a computer executable platform including a hard disk partition and a host protection area, wherein hard disk partition stores a normal operating system and the host protection area stores a multimedia operating system kernel, the method comprising:
receiving a power on-switch signal, loading a basic input output system (BIOS) into a memory and executing power self test sequence;
detecting a multimedia on-switch mode signal; and
when the multimedia on-switch mode signal is detected, the BIOS executing the following steps:
setting the host protection area to an access status;
reading an on-switch loading program; and
loading the multimedia operating system kernel.

2. The method of claim 1, further comprising a step of loading an application program after loading the multimedia operating system kernel.

3. The method of claim 1, wherein when no multimedia on-switch mode signal is detected, the BIOS sets the host protection area to a protection status and loads the normal operating system.

4. The method of claim 1, wherein the multimedia on-switch mode signal is an interrupt signal.

5. The method of claim 1, wherein the multimedia operating system kernel includes a driver program of a multimedia device.

6. The method of claim 5, wherein the multimedia device is an optical disk drive, a sound effect device, or a video device.

7. The method of claim 1, wherein the application program is capable of broadcasting sound data, image data, and picture data.

8. The method of claim 1, wherein the multimedia on-switch mode signal is received from a shortcut key or combined keys of an input device.

9. An activating method of a computer multimedia function, wherein a host protection area stores an on-switch loading program and a multimedia operating system kernel, the method comprising:
receiving a multimedia on-switch mode signal;
according to the multimedia on-switch mode signal, setting the host protection area to an access status;
reading the on-switch loading program stored in the host protection area into a memory; and
loading the multimedia operating system kernel by the on-switch loading program stored in the host protection area.

10. The method of claim 9, wherein the host protection area further stores an application program.

11. The method of claim 9, further comprising a step of loading an application program stored in the host protection area.

12. The method of claim 9, wherein the multimedia on-switch mode signal is an interrupt signal.

13. The method of claim 9, wherein the multimedia operating system kernel includes a driver program of a multimedia device.

14. The method of claim 13, wherein the multimedia device is an optical disk drive, a sound effect device, or a video device.

15. The method of claim 9, wherein the application program is capable of broadcasting sound data, image data, and picture data.

16. The method of claim 9, wherein the multimedia on-switch mode signal is received from a shortcut key or combined keys of an input device.

17. An activating method of a computer multimedia function, wherein a host protection area stores an on-switch loading program and a plurality of multimedia operating system kernels, whereby a specific multimedia operating system kernel is loaded according to different on-switch mode signals, the method comprising:
receiving a multimedia on-switch mode signal, wherein the multimedia on-switch mode signal determines a corresponding multimedia operating system kernel;
according to the multimedia on-switch mode signal, setting the host protection area to an access status;
reading the on-switch loading program stored in the host protection area into a memory; and
activating the on-switch loading program to load and execute the multimedia operating system kernel.

18. The method of claim 17, wherein the multimedia on-switch mode signal is an interrupt signal.

19. The method of claim 17, wherein the multimedia operating system kernel includes a driver program of a multimedia device.

20. The method of claim 19, wherein the multimedia device is an optical disk drive, a sound effect device, or a video device.

21. The method of claim 17, wherein the multimedia operating system kernel includes a corresponding application program.

22. The method of claim 17, wherein the multimedia on-switch mode signal is received from a shortcut key or combined keys of an input device.

23. The method of claim 17, further comprising a step of loading an application program stored in the host protection area.
